(19) United States
(12) Patent Application Publication
(10) Pub. No.: US 2014/0249904 A1
(43) Pub. Date: Sep. 4, 2014

(54) Systems and Methods for Managing a Virtual Card Based on Geographical and Balance Information

(71) Applicant: e2interactive, Inc. d/b/a e2Interactive, Inc., Atlanta, GA (US)

(72) Inventors: David A. Nelsen, Tigard, OR (US); Phil M. Chakiris, Atlanta, GA (US)

(73) Assignee: e2interactive, Inc. d/b/a e2Interactive, Inc., Atlanta, GA (US)

(21) Appl. No.: 14/276,543

(22) Filed: May 13, 2014

Related U.S. Application Data
(63) Continuation-in-part of application No. 12/565,694, filed on Sep. 23, 2009.

(51) Int. Cl. G06Q 20/34; G06Q 30/02

(52) U.S. Cl. CPC G06Q 20/351; G06Q 30/0222; G06Q 20/342
USPC 705/14.23

(57) ABSTRACT

The invention is directed to systems and methods for using a virtual gift card having an associated value, operable on a mobile device having a processor and memory, the mobile device linked to a virtual gift card manager, the method including: identifying a geographic identifier for the mobile device; matching the geographic identifier with at least one virtual gift card stored on the mobile device; determining an amount of value associated with the at least one virtual gift card; identifying any offers or promotions redeemable with the amount of value; displaying the at least one virtual gift card, the amount of value, and any offers or promotions on the mobile device; and selectively enabling a transaction utilizing the virtual gift card, the transaction based at least in part on the any offers or promotions, the transaction including a manipulation of value associated with the at least one virtual gift card.

### CROSS-REFERENCE TO RELATED APPLICATIONS

This application is a continuation-in-part of U.S. patent application Ser. No. 12/565,694, filed on Sep. 23, 2009 entitled “SYSTEMS AND METHODS FOR MANAGING A VIRTUAL CARD BASED ON GEOGRAPHICAL INFORMATION,” which in turn claims claims priority to U.S. Provisional Patent Application No. 61/100,574 filed Sep. 26, 2008 entitled “SYSTEMS AND METHODS FOR INTEGRATING A GEOGRAPHIC IDENTIFIER WITH A VIRTUAL CARD SYSTEM” the entire contents of each which are hereby incorporated herein by reference for all purposes.

### FIELD

The present disclosure relates generally to systems and methods for managing and using a virtual card based on geographical information.

### BACKGROUND AND SUMMARY

Plastic gift cards have become a popular form of payment in today's marketplace. Consumers typically purchase a select goods and services system's gift card and then present the plastic gift card to the brick and mortar location for redemption. Many times the purchaser of the gift card carries the gift card in their wallet for a period of time prior to redemption. During redemption, the user must sort through his wallet and hope that the card has not been lost or otherwise misplaced.

As the use of gift cards has become more and more popular, consumers are likely to carry a number of such gift cards in their wallet. Typically, the gift cards are redeemable at a single goods and services system or a limited number of goods and services system's establishments. As such, the number of gift cards that are carried and maintained by an individual consumer is significant. A consumer may have similar problems with plastic and paper loyalty cards, such as membership cards, rewards card, points card, advantage cards, and/or club cards.

The inventors herein have recognized the difficulties of managing the large number of such cards which are maintained by a consumer. Due to the number of such cards that a consumer may manage, consumers may physically stretch their wallets to carry the large number of cards. Further, it may be difficult to locate a specific card for presentation to a merchant and/or a card may become lost. As such, the consumer may desire to reduce the number of cards that are carried in the physical wallet or purse.

Moreover, many stored value cards—including virtual cards—do not provide for a user to receive a residual value back in cash. Although some states require such refund of unused funds, in various situations such residual value may continue to be associated with the card. In some circumstances, the residual value on the card may not be conducive to purchases at the specific merchant. For example, a residual value of $2.98 may not be enough to make a stand-alone purchase (that is, without another value source) at a merchant that sells high-end electronics.

However, such residual value—if not used for a certain period of time—may amount to unclaimed funds subject to state escheat laws. In addition to having to abide by such laws, from an accounting perspective residual value may also represent an outstanding liability for the merchant. In aggregate, this may have a significant impact on the account practices—and inconvenience and difficulty thereof—of the merchant.

Accordingly, it is desirable to encourage a customer to utilize any existing balance or residual value that may be present on a stored value card or virtual card. In order to encourage the user to use the residual value, various offers and/or promotions that are relevant to the amount of residual value may be presented to the user.

As noted above, a residual value may not be significant to make stand-alone purchases at one retailer (for example, a high-end electronics merchant), but may be sufficient for various purchases from a different merchant. Accordingly, it may be desirable to present a user with various offers or promotions that may be redeemed at a different merchant.

As the inventors herein have recognized the difficulties with the plastic issued cards, alternative methods and systems for electronic cards have been developed. These electronically-issued and managed cards are referred to herein as virtual cards. The virtual card may include, but are not limited to, one or more of a virtual gift card, a virtual loyalty card, a virtual membership card, and a virtual rewards car.

As described in more detail below, the inventors herein have provided a systems and methods for managing and using virtual cards. As such, the inventors provide herein systems and methods which enable a geographic identifier tagged to the virtual cards and/or the user's mobile computing device to enable ease of use of the virtual cards. In one example, the method includes identifying a geographic identifier for a mobile computing device and matching the geographic identifier with at least one virtual card associated with the mobile computing device. The method further includes triggering at least one virtual card feature based on a matched geographic identifier. In some examples, the at least one virtual card feature includes presenting the at least one virtual card with the matched geographic identifier. In other examples, the at least one virtual card feature includes a security feature including selectively enabling a virtual card transaction based on the at least one virtual card with the matched geographic identifier.

Further, in other examples, a method is provided including determining a distance between a mobile computing device location and at least one merchant-outlet location, the at least one merchant-outlet location associated with a card service provider and at least one virtual card, the card service provider configured to process a virtual card transaction. The method also may include selectively presenting at least one virtual card associated with the at least one merchant-outlet location on a display of the mobile computing device based on the distance between the mobile computing device location and the at least one merchant-outlet location. In this example, virtual cards that are likely to be used in a transaction may be presented on a display based on a geographical location of a mobile computing device as well as a geographical location of a merchant-outlet, enabling a user to quickly access a virtual card for use.

Aspects in accordance with some embodiments of the present invention may include a method for using a virtual gift card having a value associated therewith, the method operable on a mobile computing device having a processor and memory, the mobile computing device operatively linked to a virtual gift card manager, the method comprising: identifying a geographic identifier for the mobile computing device; matching the geographic identifier with at least one virtual gift card stored on the mobile computing device; determining an amount of value associated with the at least one virtual gift card; identifying any offers or promotions redeemable with the amount of value; displaying the at least one virtual gift card, the amount of value, and any offers or promotions on the mobile computing device; and selectively enabling a transaction utilizing the virtual gift card, the transaction based at least in part on the any offers or promotions, the transaction including a manipulation of value associated with the at least one virtual gift card.

Aspects in accordance with some embodiments of the present invention may include a method for management of one or more virtual cards included in a virtual card engine communicatively linked to a virtual card manager, the method comprising: determining a merchant-to-mobile distance between a mobile computing device location and an at least one merchant-outlet location, wherein the at least one merchant-outlet location is associated with an at least one virtual card stored on the mobile computing device; determining if the merchant-to-mobile distance is less than a first threshold value; determining the balance of the at least one virtual card; determining any promotions or offers redeemable with the balance of the at least one virtual card; and automatically displaying on the mobile computing device the at least one virtual card, the balance, and any promotions or offers.

Aspects in accordance with some embodiments of the present invention may include a method for management of one or more virtual cards included in a virtual card engine communicatively linked to a virtual card manager, the method comprising: determining a distance between a mobile computing device location of a mobile computing device and at least one merchant-outlet location, the at least one merchant-outlet location linked with a card service provider and at least one virtual card previously stored on the mobile computing device, the card service provider configured to process a virtual card transaction; determining an amount of value associated with the at least one virtual card; automatically selectively presenting the at least one virtual card linked with the at least one merchant-outlet location and the amount of value associated with the at least one virtual card on a display of the mobile computing device based on the distance between the mobile computing device location and the at least one merchant-outlet location; displaying a merchant promotion based on the at least one virtual card and the amount of value; and selectively enabling a virtual card transaction between at least one virtual card and the card service provider based on the at least one virtual card, the amount of value, and the merchant promotion, the virtual card transaction including a manipulation of value associated with the at least one virtual card.

### BRIEF DESCRIPTION OF THE FIGURES

The disclosure is illustrated by way of example and not by way of limitation in the figures of the accompanying drawings, in which the like references indicate similar elements and in which:

FIG. 1 shows an exemplary schematic illustration of a virtual card management system according to an embodiment of the present disclosure, in accordance with some embodiments of the present invention.

FIG. 2 is a general process flow of a method for identifying a geographic identifier, matching the geographic identifier and triggering at least one virtual card feature based on the matched geographic identifier, in accordance with some embodiments of the present invention.

FIG. 3 is a process flow of a method for presenting a virtual card on a display as well as selectively enabling a virtual card for use in a virtual card transaction based on geographical data, in accordance with some embodiments of the present invention.

FIG. 4 shows an examples of a mobile computing device which may present various content windows on which one or more virtual cards may be displayed based on geographical data, in accordance with some embodiments of the present invention.

FIG. 5 shows an examples of a mobile computing device which may present various content windows on which one or more virtual cards may be displayed based on geographical data, in accordance with some embodiments of the present invention.

FIG. 6 shows an examples of a mobile computing device which may present various content windows on which one or more virtual cards may be displayed based on geographical data, in accordance with some embodiments of the present invention.

FIG. 7 shows an exemplary screen shot of a goods and services system administration site for use in a virtual card management system, in accordance with some embodiments of the present invention.

FIG. 8 shows a general process flow of a method for identifying a geographic identifier, matching the geographic identifier and triggering at least one virtual card feature and offer based on the matched geographic identifier, in accordance with some embodiments of the present invention.

FIG. 9 illustrates an exemplary process flow of a method for presenting a virtual card on a display as well as selectively enabling a virtual card for use in a virtual card transaction based on geographical data and a certain offer or promotion, in accordance with some embodiments of the present invention.

FIG. 10 shows an example of a mobile computing device which may present various content windows on which one or more virtual cards may be displayed offers or promotions associated with both a proximate merchant and an existing balance of a virtual card, in accordance with some embodiments of the present invention.

FIG. 11 shows an example of a mobile computing device which may present various content windows on which one or more virtual cards may be displayed offers or promotions associated with a proximate merchant and an existing balance of a virtual card, as well as competitor offers, in accordance with some embodiments of the present invention.

### DETAILED DESCRIPTION

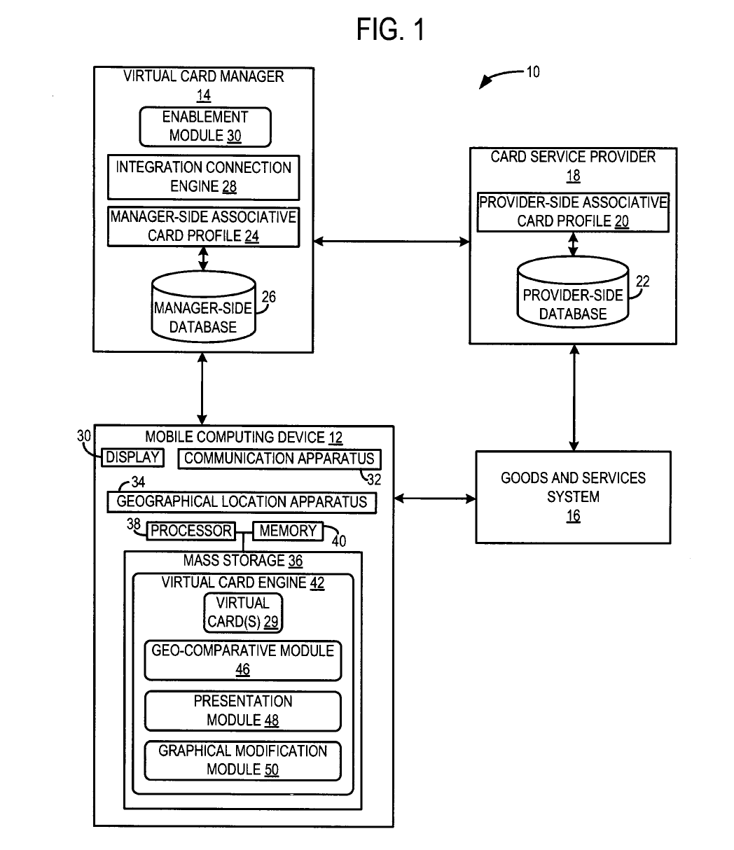

FIG. 1 shows an exemplary schematic illustration of a virtual card management system 10 according to an embodiment of the present disclosure. As described below, the system may among other features, be configured to integrate a geographic identifier with a virtual card system. Integration of the geographic identifier with a virtual card may enable ease of use of the virtual card, authentication of the virtual card and/or enhanced functionality of the virtual card. As a non-limiting example, a virtual card management system 10, such as the example shown in FIG. 1, may be adapted for use with a geographic identifier. The geographic identifier may trigger one or more virtual card features. For example, in some systems the geographic identifier may trigger display of a select virtual card or cards based on proximity of a user's mobile computing device to a merchant-outlet. In this way, a user may quickly access and use a virtual card without having to sort through a large number of cards. In other examples, the system may be configured to trigger various security features based on the geographical location of the mobile computing device and the geographical location of the merchant-outlet to enhance security and authentication of the virtual card, thus decreasing the likelihood of fraudulent use of a virtual card by a third party.

Virtual card, as used herein, may be an electronically-issued and/or electronically maintained virtual value card which may provide access to a virtual value. A virtual value may be any type of privilege, monetary or non-monetary. For example, a virtual value card may be a stored value card which may include but is not limited to a virtual gift card, a virtual loyalty card, a virtual rewards card, a prepaid card, or other suitable virtual card that holds prepaid value. The stored value card may have monetary or other forms of value stored on the virtual card. In another example, a virtual value card may be a virtual membership card which such stored value includes membership privileges and/or identification-related privileges. An example of virtual membership cards may include, but are not limited to virtual identification cards, club cards, promotional cards, identification cards (ID) cards, membership cards. The membership privileges and/or identification-related privileges may include identification of a holder of the card as an approved party or member, identification of a consumer as meeting certain prescreened criteria, etc.

As depicted in FIG. 1, virtual card management system 10 may include a mobile computing device 12, a virtual card manager 14, at least one goods and services system 16, and at least one card service provider 18. One type of exemplary transaction may include an electronic transaction, such as a virtual card transaction. A virtual card transaction may include communication between two systems, devices, etc., in which value and/or privilege data is exchanged and/or manipulated. It will be appreciated that virtual card transactions may include stored value transactions, such as monetary transactions in which stored value of a virtual card is adjusted. Additionally, the virtual card transactions may also include management of electronic privileges (e.g. card holder privileges) such as electronic access to certain types of data. For example, a virtual card transaction may include deducting value from a virtual card in exchange for a good or service at a merchant-outlet location associated with a goods and services system, such as system 16. Further in other examples, a virtual card transaction may include scanning a virtual membership card retained on a mobile computing device at a merchant-outlet location associated with a goods and services system and granting access privileges to the merchant-outlet location.

Mobile computing device 12 may be any suitable computing device that enables a user to store and maintain one or more virtual cards which may be redeemed or used with a goods and services system 16. For example, the mobile computing device may be a smart phone, a hand-held computing device, an advanced PC-like capable mobile device, a laptop computer, a portable media player, etc. In some embodiments, the mobile computing device may run an identifiable operating system's software and provide a standardized interface and platform for applications. The mobile computing device may be networked to one or more communication networks, such as a public network (e.g. the Internet) and/or one or more private networks, to enable communication with associated systems and devices, or in some examples, for authentication of the virtual card.

Mobile computing device 12 may include a display 30 configured to present graphics on the device. The mobile computing device may also include a communication apparatus 32 facilitating wired and/or wireless communication between the mobile computing device and associated systems and devices (e.g. the virtual card manager, the goods and services system, and/or the card service provider).

The mobile computing device may further include a geographical location apparatus 34 configured to determine a geographic identifier, such as the geographical location (e.g. longitude and latitude, longitude and/or latitude ranges, street address, zip code, geographic position, etc.) of the mobile computing device. In some embodiments, the geographical location apparatus may be a global positioning receiver configured to receive location data and determine the location of the mobile computing device from the location data. The location data may be sent from a Global Positioning System (GPS). Therefore, the location data which may be considered as a geographic identifier, may be a GPS signal in such an example. However, it will be appreciated that other suitable geographical location apparatuses (e.g. GPS emulator or other systems) may be utilized in some embodiments. For example, a geographical location apparatus configured to determine the position of the mobile computing device via triangulation utilizing 3 or more cellular sites (e.g. cell tower) may be utilized, in other embodiments.

The mobile computing device may include various software applications stored on mass storage 36 and executable via a processor 38 using portions of memory 40. In some embodiments, mass storage 36 may be a hard drive, solid state memory, a rewritable disc, etc. The mass storage may include various programmatic elements such as a virtual card engine 42 configured to manage the one or more virtual cards 29. As provided above, the virtual cards may be virtual value cards, such as virtual gift cards, virtual membership cards, virtual loyalty card, etc. Each virtual card may include card data such as an identification (ID) number, a stored value, a name, a bar code, image data (e.g. picture of a card holder), data corresponding to the associated goods and services system through which the virtual card may be used, etc. The virtual card engine may be a software application configured to implement various virtual card functions to enable ease and use of the virtual cards.

It will be appreciated that in some embodiments a browser-based virtual card engine may be utilized. In other words, the virtual card engine may be executed on a remote Internet server accessible via the mobile computing device. In some examples, when a browser-based virtual card engine is used, the card service provider or associated goods and services system may manage various virtual card functions. However, it will be appreciated that in other embodiments the card service provider may be inhibited from managing the virtual card functions, e.g. modifying various characteristic of the virtual cards in the virtual card engine.

As illustrated, a virtual card manager 14 may be communicatively linked with one or both of mobile computing device 12 and/or card service provider 18 or goods and services system 16. Virtual card manager 14 may be configured to manage a plurality of virtual cards. In some examples, the virtual card manager may include at least one manager-side associative card profile 24. The manager-side associative card profile may be stored in a manager-side database 26.

In some examples, the manager-side associative card profile 34 may include virtual card data such as stored value (e.g. monetary value, privilege value), identification (ID) data, (e.g. ID number or pictures), card holder names and other card holder data, personal identification codes or passwords, etc. A selected manager-side associative profile may be accessed and adjusted during a virtual card transaction.

The virtual card manager further may include an integration connection engine 28 configured to communicatively link the virtual card manager and the card service provider 18 via an API or other software communication standard included in the card service provider. In this way, the virtual card manager may communicate with the card service provider. When a plurality of card service providers are communicatively linked to the virtual card manager at least a portion of the card service providers may utilize different communication protocols, communication hardware, security protocols, etc. Thus, the integration connection engine allows the virtual card manager to interact with a number of different card service providers. In other embodiments, the card service provider may wish to use an API or other software provided by the virtual card manager to enable communication. In further examples, the card service provider may include other methods or systems for communicating with the virtual card manager.

Additionally, it should be appreciated that the integration connection engine 28 may include at least one virtual card adapter configured to modify the data sent to and received from the goods and services system into a common programming language, such as XML. However, in other embodiments the integration connection engine may not include the virtual card adapter.

The virtual card manager may include an enablement module 30 configured to selectively enable a virtual card transaction between a virtual card and a corresponding card service provider. Therefore, in some example systems, the enablement module may select an enabled or disabled state of a virtual card. It will be appreciated the virtual card may be “active” while the state of the virtual card is adjusted (e.g. selection of an enabled or disabled state). An enabled state may include a state in which a virtual card transaction between a virtual card and a corresponding card service provider is permitted and a disabled state may include a state in which a virtual card transaction between a virtual card and a corresponding card service provider is inhibited.

In one example, virtual card manager 14 may be configured to manage various security features of the virtual cards such as selective enablement (e.g. access control via authentication). For example, use of a virtual card may be selectively enabled (e.g. enabled or disabled). It will be appreciated that the virtual card may have an “activated” status while the virtual card is selectively enabled. Thus, the virtual card may be “activated” but in an enabled or disabled state. In this way, use of the virtual card may be quickly turned “on” and “off” without deactivating the virtual card, thereby enhancing the security of the virtual card when compared to plastic gift cards which remain in an enabled state subsequent to activation.

As a further illustration of an example system, enablement module 30 may be configured to selectively and periodically enable a virtual card transaction between at least one virtual card and a corresponding card service provider based on predetermined authentication rules (also referred to as security rules) may be associated with a virtual card. In some examples, the authentication rules may be preset by the card service provider, the merchant and/or the virtual card manager. The authentication rules may be implemented such that the state of the virtual card (e.g. enabled state, disabled state, etc.) may be managed by the virtual card manager. It should be appreciated that the virtual card manager may be a remote server in some systems, while in other systems, the virtual card manager may be on or at least partially stored or executed on the mobile computing device.

The enablement module may determine an enabled or disabled state for the virtual card based on the authentication rules. As described above, the virtual card may be “active” while the state of the virtual card is adjusted. A corresponding card service provider may manage the stored data pertaining to the virtual card in use. The stored data may be included in the provider-side associative card profile 20 and/or in the manager-side associative card profile 24.

In some examples, periodically authenticating by selectively enabling a virtual card transaction may include toggling the card from a disabled state to an enabled state at select times, such as prior to the virtual card use. This toggling between the enabled state and disabled state may be considered periodic authentication. The value data stored on the virtual card engine and/or provider-side associative card is retained during this process. The value data may include monetary data and/or membership service data. It will be appreciated that different methods may be used to toggle the state of the virtual card. For example, in some systems, the toggling may enable the stored value on and off depending on the capabilities offered by a specific card service provider. However, it will be appreciated that other techniques may be utilized to enable and disable a virtual card.

Selective enablement (e.g. access control via authentication) of a virtual card is disclosed and example systems and methods to manage various security features of virtual cards are disclosed in U.S. Provisional Application No. 61/094,654 filed Sep. 5, 2008 entitled Systems and Methods for Periodic Authentication of a Virtual Card, inventor David Nelsen and U.S. application Ser. No. 12/554,792 filed Sep. 4, 2009 entitled SYSTEMS AND METHODS FOR AUTHENTICATION OF A VIRTUAL STORED VALUE CARD. The disclosures of which are hereby incorporated by reference for all purposes.

As described above, virtual card manager 14 may also be communicatively linked to a card service provider 18 and/or a goods and services system 16. The goods and services system may include a point of sales (POS) system which may include software and hardware to manage electronic transactions. Depending on the system, the goods and services system may also be configured to virtually or electronically issue card data such as loyalty data, membership data, value data (e.g. monetary data), etc., through a mobile computing device or other electronic device such as through the system illustrated in FIG. 1.

In some systems, the card service provider may enable the goods and services system to perform card transactions, including integrating virtual card transactions into a goods and services system. As briefly mentioned above, card service provider 18 may be a third party stored value system or a module or software component of the goods and services system's existing POS system created or used by the goods and services system to track the virtual card services on behalf of the goods and services system. A goods and services system's POS Provider may be software, hardware, and/or other devices configured to process goods and services transactions at a location. Often times the POS may have a module or built in capability, thus making the POS System also a “Card Service Provider”. In other words, in some systems, card service provider 18 may be included in the goods and services system 16.

Card service provider 18 may be configured to generate at least one provider-side associative card profile 20, each associative card profile corresponding to a virtual card. The provider-side associative card profile may be stored in a provider-side database 22. The provider-side associative card profile may include virtual card data such as stored value (e.g. monetary value, point value), identification (ID) data (e.g. ID number, personal identification number), a card holder's name, etc. A selected provider-side associative card profile may be accessed and adjusted during a virtual card transaction. It will be appreciated that the provider-side associative card profile may be included in the goods and services system, in some embodiments.

As described above, virtual cards may be managed by the virtual card manager for use and/or redemption with a goods and services system 16. The goods and services system (also referred to generally as the merchant) may be associated with one or more merchant-outlets (e.g. brick and mortar stores, clubs, venues, etc.). Example merchant-outlets may include one or more coffee shops, restaurants, restaurants, stores, hotels, supermarkets, sports clubs, etc. In other examples, the goods and services system may process transactions over the Internet. It should be appreciated that the card service provider may be integrated with a specific goods and services system and/or may provide support for a plurality of goods and services systems.

Additional examples of use of a virtual card are provided are disclosed in U.S. Provisional Application No. 61/098,669 filed Sep. 19, 2008 entitled SYSTEMS AND METHOD FOR MANAGING AND USE OF A VIRTUAL CARD SYSTEM, inventor David Nelsen and U.S. application Ser. No. 12/562,091 filed Sep. 17, 2009 entitled SYSTEMS AND METHODS FOR MANAGING AND USING A VIRTUAL CARD. The disclosures of which are hereby incorporated by reference for all purposes.

In the present system, as described above, the mobile computing device may determine a geographic identifier which may be matched with various merchant databases to trigger one or more virtual card features. For example, merchant-outlet location data may be included in the manager-side database 26.

Merchant-outlet location data may include geographical position data (e.g. longitude and latitude, latitude and/or longitude range, zip code, street address, etc.) corresponding to one or more merchant-outlets. It will be appreciated that each merchant-outlet may have a corresponding data set which may include the geographical position data of the merchant-outlet as well as the name of the merchant, associated goods and services system, and/or card service provider.

In some examples, the merchant-outlet location data may also be stored on the provider-side database 22 and/or the mobile computing device. Matching of merchant-outlet location data with the mobile computing device geographic identifier may enable authentication and/or enhanced usability to the virtual card system.

As such, in one example, the mobile computing device 18, may include a virtual card engine 42 with geo-identification modules that enable virtual card management functions related to the geographic identifier, including a geo-comparative module 46, a presentation module 48, and/or a graphical modification module 50. As an example, the geo comparative module 46 may be configured to determine a distance between a mobile computing device location and at least one merchant-outlet location, which may be referred to herein as a merchant-to-mobile distance. In this way, the geo-comparative module can determine the distance between the location data generated via the geographical location apparatus and merchant-outlet location data (e.g. a merchant-outlet location data set).

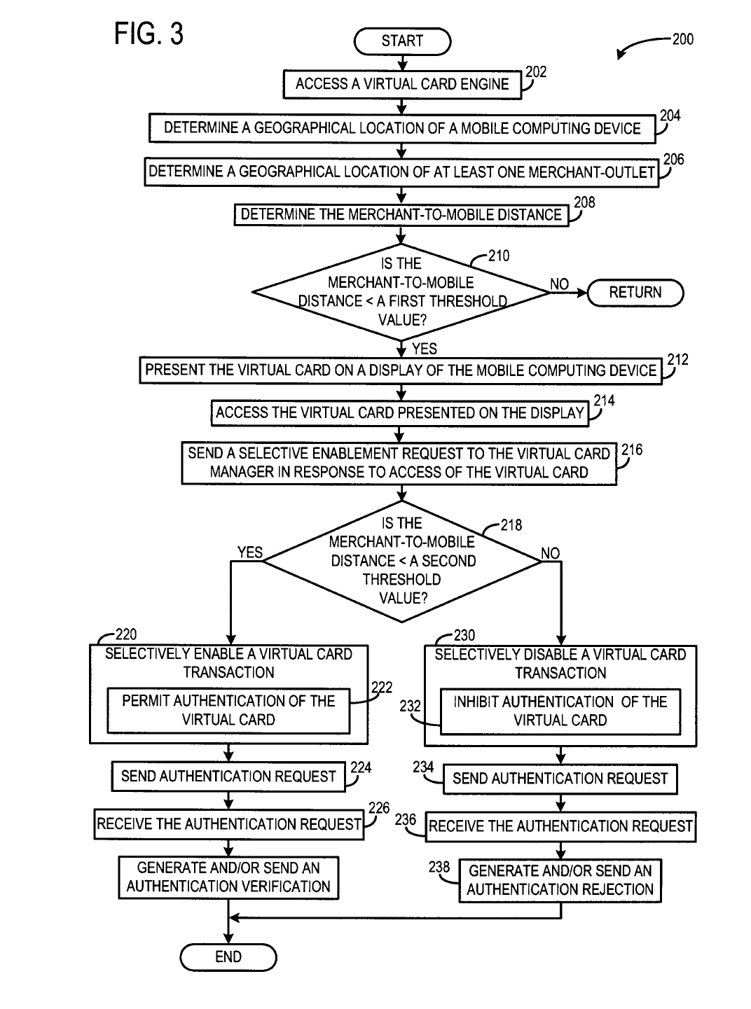

The merchant-to-mobile distance may be associated with one or more virtual cards configured to implement a transaction via a card service provider at the merchant-outlet location. Therefore in some examples, the merchant-to-mobile distance may be stored and updated on a virtual card. Furthermore, the virtual card manager may be configured to selectively enable or trigger (e.g. permit authentication) a virtual card transaction between a virtual card and a card service provider based on the merchant-to-mobile distance. In this way, the security of a virtual card may be increased. Selective enabling a virtual card based on the merchant-to-mobile distance is discussed in greater detail herein with regard to FIG. 3.

In other embodiments, the geo-comparative module 46 may be implemented by the virtual card manager. In this way, the virtual card manager may be configured to determine the merchant-to-mobile distance. When the geo-comparative module is implemented by the virtual card manager, the geo-comparative module may refresh data to the goods and services system's software, showing the goods and services system that authentication of a virtual card has occurred. In this manner, the goods and services system may be aware of virtual cards that are likely to be used in a transaction. The goods and services system may also select the virtual cards that were used to implement a transaction after authentication. This information may be sent to the virtual card manager and then to a mobile computing device to confirm a successful check-in, authentication, successful purchase, etc.

The virtual card engine may further include a presentation module 48 configured to selectively present associated data based on the geographic identifier. For example, the presentation module may be configured to present a virtual card or access to a virtual card on display 30 based on predetermined virtual card criteria. In some embodiments, the criteria may include the distance between the mobile computing device location and a merchant-outlet location (i.e. merchant-to-mobile distance). For example, the presentation module may present a plurality of virtual cards in a consecutive arrangement according to the magnitude of the merchant-to-mobile distance corresponding to each virtual card. In another example, the presentation module may present a set of virtual cards, each virtual card having merchant-to-mobile distance less than a threshold value. However in other embodiments, alternate or additional criteria may be used to selectively present the virtual cards on the display. Furthermore, it will be appreciated that the presentation module may also be configured to adjust the arrangement of the virtual cards presented on display 30 based on various criteria, such as the merchant-to-mobile distance. Still further, in some examples, if there are multiple cards presented on the display that have similar merchant-to-mobile distances, information such as card usage data may be used to adjust the order in which the card is presented on the display.

In some examples, the virtual card engine may be configured to adjust the virtual card location criteria. For example, the maximum number of virtual cards that can be presented on the display may be adjusted, the merchant-to-mobile threshold value may be adjusted, or the presentation feature based on the mobile-to-merchant distance may be turned off entirely if a user is experiencing difficulties.

The presentation module may enable a card holder to quickly access and use virtual cards which are likely to be used in a transaction, thereby drastically increasing the speed by which the user can pull a virtual card up for use with a card service provider. In one exemplary scenario, a user may be making a purchase at a supermarket, such as Safeway, that has a coffee shop, such as Starbucks, inside the store. When the user attempts to open the virtual card engine, the virtual card engine may display or link to the two virtual cards corresponding to the geographic identifier; a Safeway Member Card, and a Starbucks Gift Card. Even though the mobile card engine may have twenty cards available or stored, the presumption is that the card holder would want to use one of the two cards which are matched to the geographic identifier due to the user's close proximity to both of the merchant-outlets.

The virtual card engine may further include a graphical modification module 50 configured to modify the appearance of at least one virtual card presented on a display of a mobile computing device. The appearance of the virtual card may include at least one of size, color, geometric configuration, and graphical characteristics (e.g. alpha-numeric data, images, logos, brightness, etc.). In some examples, the appearance of at least one virtual card may be adjusted based on a merchant-to-mobile distance associated with the virtual card. However, in other examples the appearance of the virtual card may not be adjusted based on the merchant-to-mobile distance.

Although only a single card service provider and mobile computing device are depicted, it will be appreciated that virtual card manager 14 may act as a common platform for managing a large number of virtual cards corresponding to a plurality of card service providers. In some examples, two or more of the card service providers may have different characteristics. For example, two or more of the card service providers may utilize different communication protocols and may be linked to different goods and services systems and therefore provide different services. Furthermore, the card service provider may provide different types of card services. For example, one card service provider may provide membership card services while another card service provider may provide gift card services. In this way, a single virtual card management system can be used to manage a large number of virtual cards, facilitating scalability of the virtual card management system, thereby enhancing the market appeal of the virtual card management system.

Furthermore, in some embodiments, it should be appreciated that the virtual card manager services and/or the authentication may be managed on the mobile computing device (e.g. thick client approach), As such, the logic currently held by the virtual card manager may be stored directly on the mobile computing device that allows the mobile computing device to determine which card service provider to communicate or other higher level decision abilities. However, in other embodiment a thick client approach may not be utilized.

A thick client approach may for example maintain the cards authentication on the device of which it resides, and be able to implement various virtual card management functions (e.g. selective enablement), based on the virtual card in use. In this manner, the mobile computing device making decisions that may normally have been made from the virtual card manager may be transferred to the mobile computing device itself. However, other techniques may be utilized to maintain authentication in other embodiments.

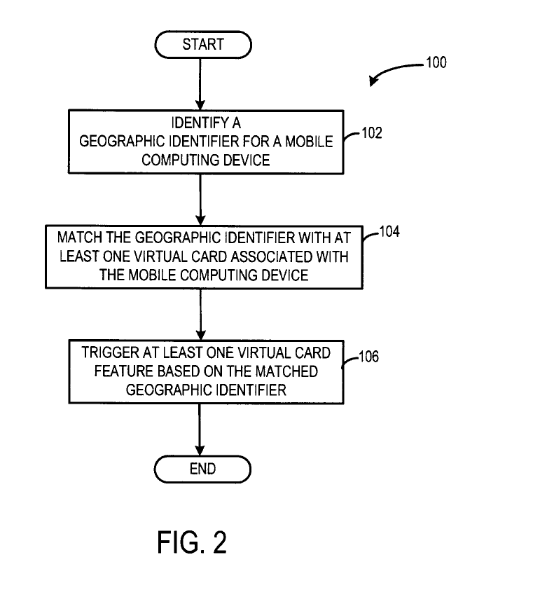

FIG. 2 illustrates generally at 100 a method for managing a virtual card based on geographical information. In the illustrated example, at 102, a geographic identifier is identified for a mobile computing device. The geographic identifier may be matched with at least one virtual card associated with the mobile computing device at 104. Matching the geographic identifier may include determining whether one or more virtual cards associated with the mobile computing device are linked with a location which is in a preselected geographic range of the identified geographic identifier. In other example, matching may include identifying one or more virtual cards which have linked geographic locations which are closest to the geographic location of the geographic identifier. The linked geographic locations may be pre-associated with the virtual cards. For example, the linked geographic locations may be retained in a merchant location repository which may be retained on the mobile device, the virtual card manager, the card service provider and/or the goods and services system.

If one or more virtual cards are matched with the geographic identifier, then, at 106, at least one virtual card feature may be triggered. The virtual card feature may be a display feature, such that one or more matched virtual cards are presented on the mobile computing device display. In some examples, presentation of the matched virtual cards may be automatic, such that the virtual card feature is automatic display of the one or more matched virtual cards. In other systems, user input may be requested for display of the matched virtual cards.

In other examples, the virtual card feature may be a security feature to enhance security of the use of the virtual card. For example, the security feature may provide authentication which may be enabled upon identification of a matched virtual card. The security feature may further initiate an authentication period, such as a time period, for use of a virtual card.

In some systems, virtual card features further may include display or access to promotional or informational data related to the matched virtual card or location of the cardholder displaying the virtual card. For example, the virtual card features may include display of merchant information, including, but not limited to merchant-related content, promotions, merchant core information, e.g. merchant hours, merchant requirements, etc., and/or merchant promotion information, e.g. rewards, points, coupons, e.g. legal terms & conditions of use specific to the location, etc. Further, in some example, virtual card features may include display of related content, e.g. information, advertisements and/or promotions where such content is based on the cardholder's location, the cardholder's location when displaying a virtual card, and/or a matched location between a cardholder and one or more virtual cards. Moreover, the virtual card feature may be a feature that changes the display or appearance of the card. For example, if a mobile-computing device geographic location is matched a virtual card geographic location, then the card may display on the mobile-computing device with information tied to the nearest merchant-outlet location, promotions related to the nearest merchant-outlet location, and specials related to the merchant-outlet location. The images on the card, the card itself, features on the card, appearance of the card, etc. may change based on the nearest merchant-outlet location such that the appearance and the experience with the card may be customized based on the geographic location of the mobile computing device when accessing the card.

Turning now to FIG. 3, FIG. 3 illustrates a method 200 for presenting and authenticating one or more virtual cards based on a geographical location of a mobile computing device and a geographical location of a merchant-outlet. In some embodiments, the method may be implemented utilizing the systems, devices, etc., described above. However, in alternate embodiments other suitable systems, devices, etc., may be utilized to implement method 200. It should be appreciated in some example, not all steps of the method are required and the order of such steps may be altered.

At 202 the method includes accessing a virtual card engine. Next at 204 the method includes determining a geographical location or geographic identifier for the mobile computing device. As previously discussed, the geographical location of the mobile computing device may be determined by a geographical location apparatus (e.g. GPS receiver). In some examples, the virtual card engine may be executed on the mobile computing device. However, the virtual card engine may be accessed via a browser in other examples.

Next at 206 the method includes determining a geographical location of at least one merchant-outlet. It will be appreciated that the merchant-outlet location may be stored in a database on a mobile computing device, a virtual card manager, and/or a card service provider. Therefore, in some examples, determining the geographical location of the merchant-outlet may include looking up location data in a database. However, in other examples other suitable techniques may be used to determine the geographical location of the merchant-outlet. Furthermore, it will be appreciated that the merchant-outlet location may be selected based on a virtual card stored in the virtual card engine. In particular, the merchant-outlet corresponding to a card service provider through which a transaction may be implemented via the virtual card may be selected.

Next at 208 the method includes determining the merchant-to-mobile distance. As previously discussed the merchant-to-mobile distance may be considered the distance between the mobile computing device location and the merchant-outlet location.

In some embodiments, at 210, the method may include determining if the merchant-to-mobile distance is less than a first threshold value. In this way, the merchant-to-mobile distance and a corresponding virtual card may be selected based geographical location criteria. In some examples, the virtual card engine may establish the first threshold value. However in other examples the card service provider may establish the first threshold value. In other embodiments, alternate criteria may be used to determine the selected virtual card. For example, a set of X number of cards having the shortest corresponding merchant-to-mobile distance may be selected. In such an example, steps 202-208 may be repeated multiple times until the card set has been filled with the predetermined number (i.e. X) of cards.

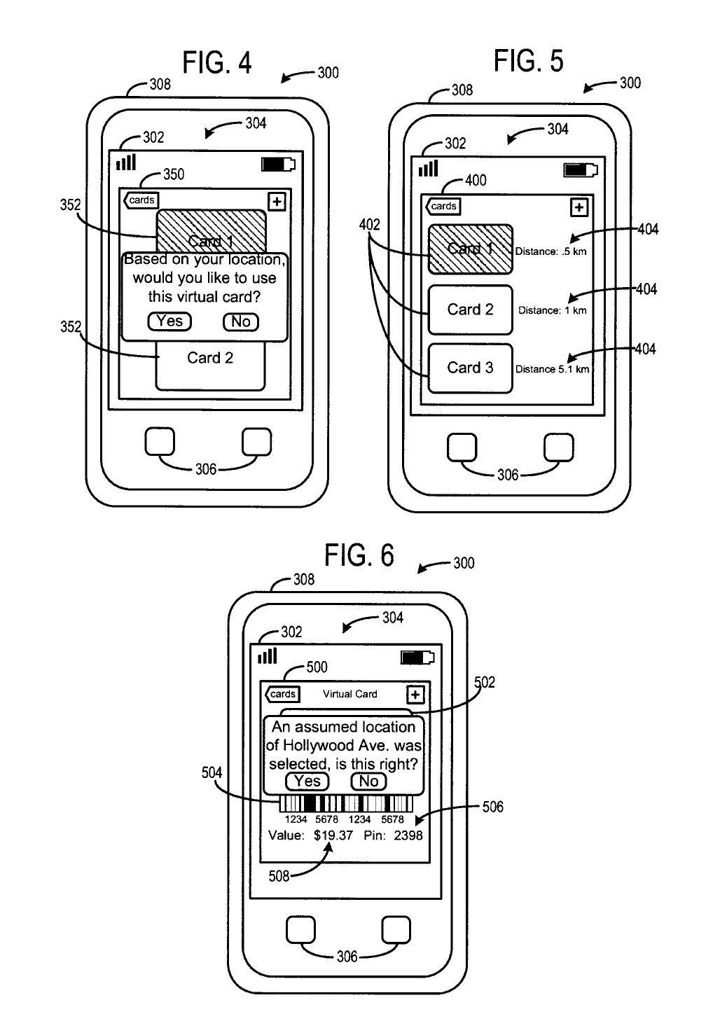

If it is determined that the merchant-to-mobile distance is not less than the first threshold value (NO at 210) the method returns to the start or alternatively in other embodiments ends. However, if the merchant-to-mobile distance is less that the first threshold value (YES at 210) the method may include at 212 presenting the virtual card corresponding to the merchant-to-mobile distance on a display of the mobile computing device. In this way, a virtual card may be quickly and accurately selected just prior to use, decreasing the amount of time a user may spend sorting through virtual cards stored in the virtual card engine. FIGS. 4 and 5 illustrated exemplary depictions of displays on which one or more virtual cards are presented based on the merchant-to-mobile distance, the display included in a mobile computing device.

The method may end after presentation of the virtual card. For example, a user may select not to use a virtual card. In other systems, the presentation of the virtual card may include presentation or access to additional virtual card features or merchant information or promotion.

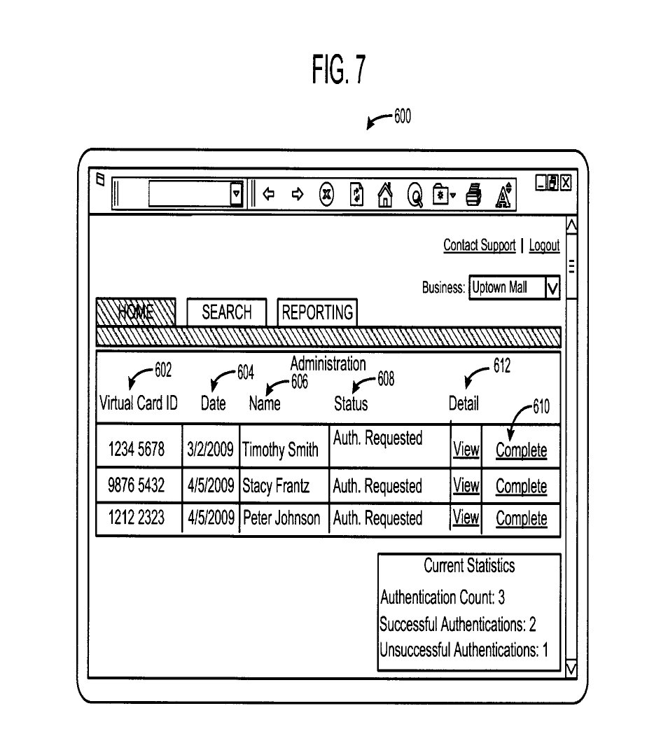

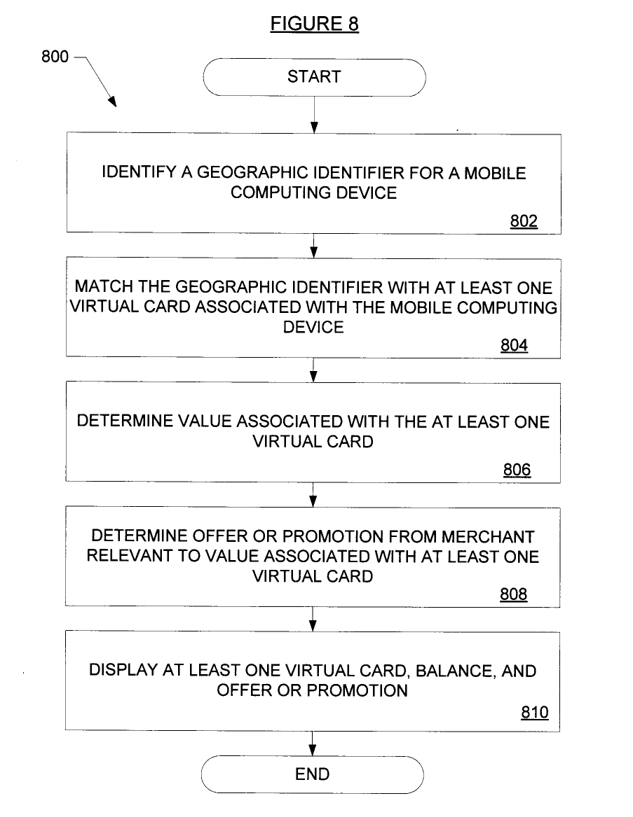

In some systems, the method may continue at 214. At 214 the method includes accessing the virtual card presented on the display. FIG. 7 illustrates an exemplary depiction of a display in which a virtual card has been accessed, the display included in a mobile computing device. It should be appreciated that the virtual card may be used in accordance with the respective virtual card system at this juncture. Steps 216-238 illustrate a specific authentication transaction which uses the geographic identifier, however other methods may be used to authenticate and enable use of the virtual card.

Although shown where the virtual card is presented on a display at 212, it should be appreciated that in some systems, a selective enable request may occur automatically without display or selection by the user. Thus, in some systems, the determination of the merchant-to-mobile distance may be automatically determined and where such distance is below a threshold value, the system may provide automatic selective enablement of a virtual card without user input. In such systems, the user may not need to present and/or access the virtual card on the mobile computing device to enable the authentication of the virtual card.

Continuing with FIG. 3, in some embodiments, the method, at 216, may include sending a selective enablement request to the virtual card manager in response to accessing the virtual card. As discussed above, it should be appreciated that in some embodiments, steps 204-210 may be optional such that a merchant-to-mobile distance is not determined in regards to display of virtual cards. Thus, the method starting at 216 may be a stand-alone method for use to authenticate a virtual card during presentation.

After a selective enablement request is made to the virtual card manager, the method may proceed to 218 where the method includes determining if the merchant-to-mobile distance is less than a second threshold value. However in other embodiments, it may be determined if the merchant-to-mobile distance is within a range of values. Furthermore, it will be appreciated that in some examples the first threshold value may be different from the second threshold value. Additionally, the second threshold value may be established by the card service provider, in some examples. In other examples, the second threshold value may be established by the virtual card engine.

If it is determined that the merchant-to-mobile distance is less than the second threshold value (YES at 218) the method proceeds to 220 where the method includes selectively enabling a virtual card transaction via the virtual card manager. In some examples, selectively enabling a virtual card transaction may include at 222 permitting authentication of the virtual card.

Next at 224 the method includes sending an authentication request to the virtual card manager from the virtual card engine. At 226 the method includes receiving the authentication request at the virtual card manager. Next at 228 the method includes generating and/or sending an authentication verification to the virtual card engine from the virtual card manager based at least in part on the matched geographic identifier. It will be appreciated that the method may additionally include receiving the authentication verification at the virtual card engine.

It should be noted that the method may proceed through steps 220-228 or similar steps to enable or permit authentication or use of the card. Thus, steps 224-228 may be optional or varied depending on the method for enabling use of the card.

Further, in some embodiments, steps 230-238 may be optional such that if the merchant-to-mobile distance is greater than a second threshold value the method ends and there is no enablement or authentication of the virtual card. A dashed line has been added to indicate that steps 230-238 may be optional, alternatives to, or used in combination with, steps 220-228. In other systems, (such as in the illustrated example) the merchant-to-mobile distance may be used to selectively disable a virtual card. For example, if it is determined that the merchant-to-mobile distance is not less than the second threshold value (NO at 218) the method proceeds to 230 where the method includes selectively disabling a virtual card transaction via the virtual card manager. In some examples, selectively disabling a virtual card transaction may include at 232 inhibiting authentication of the virtual card.

As briefly mentioned above, disabling steps 230-238 are provided for exemplary purposes and may be optional or varied depending on the system. In the illustrated example, at 234, the method may include sending an authentication request to the virtual card manager from the virtual card engine and at 236, in some systems, the method may include receiving the authentication request at the virtual card manager. Next, in some systems, at 238 the method may include generating and/or sending an authentication rejection to the virtual card engine from the virtual card manager. It will be appreciated that the method may additionally include receiving the authentication rejection at the virtual card engine.

Thus, the geographical location information may be used with the virtual card manager to ensure that the mobile computing device requesting to use the card is geographically situated at the location that the card holder intends to use the card or is permitted to use the card. The virtual card may be toggled on for use with the card service manager, but also may provide security that the mobile computing device is where it is supposed to be while being used for a select virtual card. In this way, the geographical location of the mobile computing device may be used to increase the security of the virtual card engine, thereby decreasing the likelihood of fraudulent use of a virtual card by a third party. The examples shown in steps 220-238 are provided as illustrative steps and not intended to be limiting.

It should be appreciated that there may be multiple levels of authentication. In such an example, if a virtual card engine sends an authentication request and receives a rejection of the request a message may be returned to the virtual card engine and even possibly to the goods and services system. The message may alert the goods and services system or the card service provider that the device was not able to fully authenticate. In such embodiments, the goods and services system or the card service provider may request additional proof of identification, such as photo identification, to further validate the virtual card.

It is noted that under some circumstances, global positioning may be one of many ways that security can be detected for a virtual card. Outages, users not wishing to allow such positioning out of concern for right to privacy, and other factors may affect the use of such capabilities. For example, it may be that a point system is created whereby several virtual card authentication approaches are used, and a high enough score leads to a qualified authentication. A combination system may be used to ensure validation of legitimate requests for the use of virtual cards.

Steps 216-238 may be used to increase security of a virtual card transaction. As described above, the virtual card transaction may be a purchase or redemption transaction or a privilege transaction. As an example, the identification of a geographic location may be used to enable a user to gain entry or services related to a matched location. Thus, if a user has a virtual membership card for a gym, by determining the geographic identifier and matching the geographic identifier with the associated virtual membership card, a member may be automatically identified such that the membership card is authenticated upon entry to the gym. Likewise, if the virtual card include access privileges to an event, then when the geographic identifier is matched to the event location, then the virtual card may be authenticated to enable user access to the event.

FIGS. 4-6 illustrate displays for an example mobile computing device 12 of FIG. 1, in the form of a mobile phone 300. Mobile phone 300 may include a display 302, which may be analogous to display 30 of FIG. 1. The mobile phone may include suitable input devices, such as a touch screen 304, various buttons 306, a keyboard (not shown) allowing a user to manipulate the mobile computing device. It will be appreciated that in some examples, the touch screen may present a keyboard to facilitate alpha-numeric input. Additionally, software applications such as virtual card engine 42 may be stored on memory and executed via one or more processors. The memory, processor, as well as additional electronic componentry may reside within or on-board a device body 308 of mobile phone 300. Furthermore, various windows which may be presented on a display by the virtual card engine are depicted in FIGS. 4-6, enabling a user to implement various functions of the virtual card engine such as viewing a number of virtual cards as well as selecting an individual virtual card for use in a virtual card transaction.

As an example, FIG. 4 shows an exemplary virtual card management window 350. A number of depictions of physical representations 352 of selected virtual cards may be presented on the display. As described above, with the geographic identifier, one or more virtual cards which match the mobile computing device's location may be selected. If a match is identified, the virtual card may be substantially automatically presented to the card holder. In some examples, the presentation may be based on a set of rules which selects merchants within a range of the geographic indicator such that a user is presented with the most likely set of virtual cards that the user may wish to use. Further, if there are multiple cards in a wallet that match or are close in geographical location, information such as how often the user uses the card may influence the order in which the card shows up in the list of possible cards to use.

The virtual cards may be selected based on a corresponding merchant-to-mobile distance. As previously discussed the virtual cards presented on the display may have an associated merchant-to-mobile distance less than a threshold value which may be established by the virtual card engine. It will be appreciated that the virtual cards may be accessed for use, as depicted in FIG. 5 discussed in greater detail herein. Further in some examples, a pop-up window may be provided to confirm that the virtual cards presented on the display were auto-selected for use.

In some examples, a pop-up may be provided to enable a user to confirm that they would like to use an identified card. For example, the pop up may request that based on your location, would you like to use a selected virtual card? A user may confirm the selection. Similarly, a pop-up may indicate that a group of cards were auto-selected based on the geographic location of the mobile computing device.

FIG. 5 shows an exemplary virtual card management window 400. A number of depictions of physical representations 402 of selected virtual cards may be presented on the display. As, previously discussed, the virtual cards may be selected based on a corresponding merchant-to-mobile distance. In this example, a merchant-to-mobile distance 404 associated with each card is presented on the display. The virtual cards may be presented in a consecutive order (e.g. smallest to largest) based on the merchant-to-mobile distance. The virtual cards may be selected based on a corresponding merchant-to-mobile distance. As another example, the virtual cards may be presented in relation to an order of those which are used most frequently based on the mobile computing device location, etc. In some systems, the user may be able to customize the display such that the presentation and order of the cards displayed are defined according to default rules or customized rules selected by the user and/or merchant.

FIG. 6 shows an illustration of a virtual card content window 500 which may be accessed to transfer virtual card information to a goods and services system via scanning or another suitable technique such as wired data transfer or wireless data transfer (e.g. Bluetooth, infrared). In this way, a user may access one or more virtual cards via the virtual card engine and transfer card data to a card service provider to implement a virtual card transaction with the virtual card provider. However it will be appreciated that other suitable techniques may be utilized to implement a virtual card transaction. A depiction of a physical card representation 502 may be presented on the display. Additionally, a barcode 504, a PIN 506, and value data 508 may also be presented on the display. In some examples, a user image may also be displayed such that a merchant may immediately identify whether the user presenting the virtual card matches with the image on the virtual card.

Furthermore, it will be appreciated that the mobile computing device may prompt a user to confirm the geographical location of the mobile computing device, in some embodiments. For example, the geographical location (e.g. street address, zip code, longitude and latitude, etc.) may be presented on the display and a user may confirm or reject the accuracy of the geographical location of the mobile computing device. In FIG. 5, an example pop-up display shows that for a selected card the location is believed to be “Hollywood Ave.”. A user may confirm that this location is or is not correct. Such confirmation of location may be required with some merchant-outlets which may have multiple locations. In some examples a selection step, may enable a user to confirm the desired merchant-outlet location.

If the accuracy of the geographical location is not confirmed, enablement of a virtual card based on the merchant-to-mobile distance may be inhibited, in some examples. Further, in other examples, the user may not be prompted to confirm the geographical location of the mobile computing device. Additionally, the location of a virtual card transaction may be displayed, allowing the user of the virtual card engine to be quickly alerted should fraudulent use of their card occur where the user did not know of that card use occurrence.

It is noted that the merchant-to-mobile threshold distance may vary depending on the merchant's location, the merchant's request, the type of outlet, the accuracy of the global positioning of the mobile computing device and/or the geographic location of the merchant-outlet, etc. For example, the merchant-to-mobile distance for some merchants may differ based on the specific merchant location the card request is coming from. For example, a location within a store mall may need a wider range of mobile-to-merchant distance because the quality of global positioning relative to that merchant location may be less accurate than it would be for a merchant that resides within a more confined building.

It will be appreciated that the arrangement as well as the representations of the virtual cards depicted in FIGS. 4-6 are exemplary in nature and that the arrangement and appearance (e.g. size, color, geometry, graphical characteristics, etc.) of the virtual cards may be modified in other embodiments. Further, a user may have set-up options to determine if global position can be used or used only by request prior to showing cards. Furthermore, options may enable a user to lessen sensitivity of the geographic identifier (increase or decrease the threshold values for the merchant-to-mobile distances) for all cards or select cards, limit the number of cards returned per any location, and/or the ability to turn the feature on and off selectively for a set of cards or individual cards.

It is noted that in some systems, merchants may be able to gather information regarding a user's use of the merchant's virtual cards, such as membership cards. For example, a merchant may receive information that a specific user typically uses the virtual card at a select merchant location and limit or tag the virtual card to the specific location. As such, the virtual card may be identified via use of the geographic identifier, but may also verify the card holder with the intended merchant location.

Further, matched geographic identifiers may trigger display or availability of merchant information on the user mobile computing device. For example, a merchant that is within a merchant-to-mobile distance may push merchant information, including, but not limited to merchant hours, merchant requirements, merchant promotions, merchant coupons, rewards, points, etc., to the mobile computing device. Such merchant information may then increase the user's desire to proceed with a transaction with the merchant.

FIG. 7 illustrates an example screen shot 600 of a goods and services system administration site for use with the systems and methods described above according to an embodiment of the present disclosure. Screen shot 600 is an exemplary screen shot and the disclosure is not intended to be limited to the format as illustrated.

The screen shot provides feedback to a goods and services system and/or a card service provider regarding virtual card use, upcoming requests for use and/or authentication of virtual cards, etc. As depicted, data regarding a virtual card may be provided. The data may include, but is not limited to, the identification number of one or more virtual cards as shown at 602, the date of corresponding virtual card transactions as shown at 604, the name of the card holder as shown at 606, and the status of the virtual card as shown at 608. Other fields may also be provided, including information regarding the time of the authorization request, the number of authorization requests in a past period, the value, etc. The information can be used to verify and manage the user of the virtual cards and target any fraudulent attempts of use of the virtual cards.

In the illustrated screen shot, multiple card holders have successfully authenticated from their mobile computing devices. In response to successful authentication feedback may be provided to the goods and services system. In other systems, information regarding failed authentication may also be available to the good and services system or the virtual card manager. In this way, the goods and services system may track virtual card usage.

Additionally, a “complete” link is illustrated at 610 and represents the ability to remove the virtual card data from this administrative view and mark a virtual card as having actually checked in (e.g. initiated a transaction) after having authenticated from their mobile computing device.

A “view” link is illustrated at 612. The view link enables the goods and services system to review details about an authentication request, or possibly remove a virtual card that did not check-in after authentication. It should also be appreciated that the “view” link may also show the level of authentication achieved, in some embodiments. For example, if the mobile computing device received authentication from a location proximate to the merchant-outlet, details relative to the virtual card's use or additional information about the card holder (e.g. address of a user, transaction history) may be provided. Depending on the authentication rule set and the requested level of security, the goods and services system may verify the additional information to provide a higher level of security.

Further in some embodiments, an alert may also be displayed. The alert may flag authentication requests which have inconsistencies, such as virtual card authentications which are not performed proximate to the merchant-outlet (e.g. merchant-to-mobile distances exceeds a threshold value). Similarly, an alert may be displayed if there were multiple authentications requested or other anomalies which could indicate fraud or misuse of the virtual card. In this way, a goods and services system may be made aware of potentially fraudulent activity and take actions to prevent the fraudulent activity, such as disabling use of the virtual card.

It should be appreciated that the capability to review virtual cards that are in the process of authenticating may be passed through software connectivity to other components in the virtual card management system such as the card service provider and/or the POS system.

As a further example, a merchant may use a similar administration site to review the validating members entering a store or club. For example, at a member super-store (such as a Costco), virtual value card holders may be identified and listed on the administration site or provided to a 3.sup.rd party software via API or other connectivity to communicate card holder data. The merchant device may enable the user to identify which members are located in the store and which are authenticating with mobile devices. The merchant may be able to validate the user and confirm the legitimacy of the virtual card. In some example, the merchant may use the data to identify trends and offer promotions, including user targeted promotions, to users of the virtual card.

Further in some embodiments an administration site similar to the administration site depicted in FIG. 7 may be presented on a computing device included in the goods and services system. For example, when a card holder is entering a merchant-outlet a display on a computing device may be reviewed by an employee to confirm that the card holder has authorization to enter the merchant-outlet, such as to confirm membership in a club or other facility. As an illustration, the computing device may display the card holders that are currently authenticated with the card service provider. Additionally, in some systems, one or more of a user's name, image, and/or code, such as a unique identifier coded for the merchant and the virtual card (e.g. unique identifier only known by the merchant and the proper virtual card) may also be verified to confirm that the card holder has authorization to enter or use the merchant-outlet. Further in some embodiments, it should be appreciated that the aforementioned security features may be automated. Further in some embodiments the aforementioned security features may not be implemented.

As described briefly above, geographic identifier software may be integrated with the card service manager, or made available to other software for use that can allow the merchant a new level of checking capabilities. For example, the software may refresh data to the merchant's software showing the merchant the card holders that have just authenticated with their member cards. In this manner, the merchant is already aware of the people that are standing in front of them and are about to present their virtual member cards, or make use of a virtual gift or other loyalty card.

A merchant may also select on their software those card carrying members that actually showed their cards after authenticating. This information could be communicated back to the virtual card managers and then back to the mobile devices to confirm a successful check-in, authentication, successful purchase, etc.

In such a way, increased security may be obtained. For example, in such systems the only person that can request for the use of a card is the authenticated device the card resides on, and because a user that recently authenticated has just shown their picture from their card wallet, the security level is increased. Further, in systems which utilize a periodic authentication system, the window of use for that mobile device is a finite period of time (as established by the merchant). As such, the device may be authenticated, prior to actual presentation of the virtual card to a merchant.

A secondary level of authentication is thus provided. For example, when a virtual card makes a request for authentication, an authentication number, word or other alpha-numeric code or codes may be passed to the mobile device and to the merchant. When the user presents their member or other virtual card to the merchant, the merchant can verify that the authentication code matches with both the proper authentication device as well as with their software which has been updated with this information. This authentication code may then be (1) viewed and verified by the merchant (2) entered into their software to check and verify—especially if the code is not presented to the merchant's front desk person and/or (3) automatically passed to the software through blue-tooth, barcode data, other wireless communication protocol as the user presents their card.

It is noted that in some systems, the card may be set to identify a preferred or customary user based location for a card based on prior history of card use. Such rules where a card manager assumes an appropriate user based location for a card's use based on prior history of card use may be generated regardless of whether the geographical location has been, is in the process of, and/or will be identified. Such historical use location information may initially allow for quicker access to geographical related virtual card features where based on the mobile technology there may be some delay in obtaining specific location information. For example, an assumption may be made based on the card's prior use history that the card should be enabled. If it is then determined (based on the specific geographic location information) that the card holder is using the card in a location that is atypical to normal use, the card may be disabled. Such use history tagged with specific geographic location information may also be considered a flagged event for the location by which the card is going to be used where the attempted use is outside the standard deviation of card usage history by that card holder. Similarly, as another example, a coarse or rough estimate for a geographic location may be used in combination with a card's prior history of use to estimate or assume a location for the user's mobile computing device and thus the cards with potentially matched geographical locations. The assumption regarding the card being displayed or identified can then be validated or invalidated as the geographic location is determined in more detail (more specifically) pinpointed.

With reference to FIG. 8, a general process flow 800 of a method for identifying a geographic identifier, matching the geographic identifier and triggering at least one virtual card feature and offer based on the matched geographic identifier, in accordance with some embodiments of the present invention will now be discussed.

In the illustrated example, at 802, a geographic identifier is identified for a mobile computing device. The geographic identifier may be matched with at least one virtual card associated with the mobile computing device at 804. Matching the geographic identifier may include determining whether one or more virtual cards associated with the mobile computing device are linked with a location which is in a preselected geographic range of the identified geographic identifier. In other example, matching may include identifying one or more virtual cards which have linked geographic locations which are closest to the geographic location of the geographic identifier. The linked geographic locations may be pre-associated with the virtual cards. For example, the linked geographic locations may be retained in a merchant location repository which may be retained on the mobile device, the virtual card manager, the card service provider and/or the goods and services system.

At 806 the current value associated with the virtual card may be determined. This value may be determined based upon a real-time communication between the value card manager 14 and the card service provider 18, or may be based upon periodic communications.

At 808 one or more promotions or offers relevant to the current value of the virtual card may be determined. Such promotions or offers may be specific to any number of factors, including but not limited to: the current value (or residual value) associated with the virtual card, the specific merchant, the specific merchant location, the time of day or year, and/or the stock of the specific merchant that is proximate to the user.

If one or more virtual cards are matched with the geographic identifier, then, at 810, at least one virtual card feature may be triggered. The virtual card feature may be a display feature, such that one or more matched virtual cards are presented on the mobile computing device display as well as one or more associated offers or promotions. In some examples, presentation of the matched virtual cards and offers may be automatic, such that the virtual card feature is automatic display of the one or more matched virtual cards. In other systems, user input may be requested for display of the matched virtual cards and associated offers and/or promotions.

In some systems, virtual card features further may include display or access to promotional or informational data related to the matched virtual card or location of the cardholder displaying the virtual card. For example, the virtual card features may include display of merchant information, including, but not limited to merchant-related content, promotions, merchant core information, e.g. merchant hours, merchant requirements, etc., and/or merchant promotion information, e.g. rewards, points, coupons, e.g. legal terms & conditions of use specific to the location, etc. Further, in some example, virtual card features may include display of related content, e.g. information, advertisements and/or promotions where such content is based on the cardholder's location, the cardholder's location when displaying a virtual card, and/or a matched location between a cardholder and one or more virtual cards. Moreover, the virtual card feature may be a feature that changes the display or appearance of the card. For example, if a mobile-computing device geographic location is matched a virtual card geographic location, then the card may display on the mobile-computing device with information tied to the nearest merchant-outlet location, promotions related to the nearest merchant-outlet location, and specials related to the merchant-outlet location. The images on the card, the card itself, features on the card, appearance of the card, etc. may change based on the nearest merchant-outlet location such that the appearance and the experience with the card may be customized based on the geographic location of the mobile computing device when accessing the card.

Moreover, the offers and promotions may not be limited to the specific merchant. In other words, Merchant B may determine that it desires to accept Merchant A stored value. This acceptance may be for actual value, or may be merely to prevent customers from frequenting and buying items from Merchant A. Regardless of the merchant's motivations or processes, the user may be presented with offers redeemable not only at Merchant A, but also at Merchant B. Such offers may require further action on the part of the customer—for example, registering with Merchant B's loyalty program. Offers and promotions may be redeemable in store for physical goods and/or services, or may be redeemable over the communications device for digital goods and/or services.

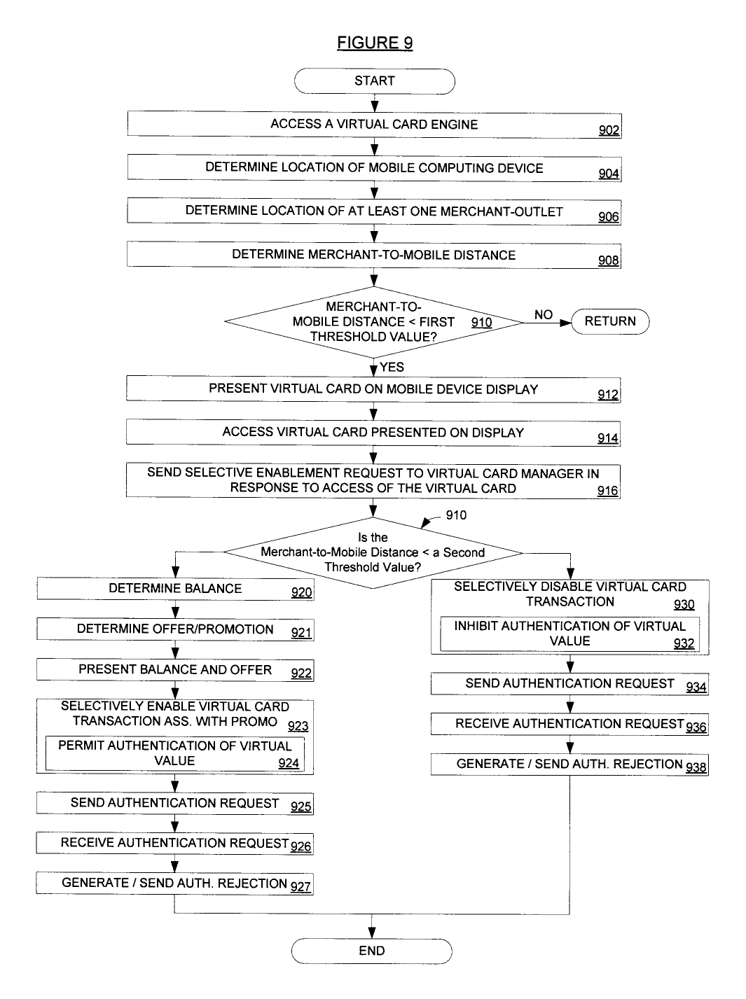

With reference to FIG. 9, an exemplary process flow 900 of a method for presenting a virtual card on a display as well as selectively enabling a virtual card for use in a virtual card transaction based on geographical data and a certain offer or promotion, in accordance with some embodiments of the present invention.

At 902 the method includes accessing a virtual card engine. Next at 904 the method includes determining a geographical location or geographic identifier for the mobile computing device. As previously discussed, the geographical location of the mobile computing device may be determined by a geographical location apparatus (e.g. GPS receiver). In some examples, the virtual card engine may be executed on the mobile computing device. However, the virtual card engine may be accessed via a browser in other examples.

Next at 906 the method includes determining a geographical location of at least one merchant-outlet. It will be appreciated that the merchant-outlet location may be stored in a database on a mobile computing device, a virtual card manager, and/or a card service provider. Therefore, in some examples, determining the geographical location of the merchant-outlet may include looking up location data in a database. However, in other examples other suitable techniques may be used to determine the geographical location of the merchant-outlet. Furthermore, it will be appreciated that the merchant-outlet location may be selected based on a virtual card stored in the virtual card engine. In particular, the merchant-outlet corresponding to a card service provider through which a transaction may be implemented via the virtual card may be selected.

Next at 908 the method includes determining the merchant-to-mobile distance. As previously discussed the merchant-to-mobile distance may be considered the distance between the mobile computing device location and the merchant-outlet location.

In some embodiments, at 910, the method may include determining if the merchant-to-mobile distance is less than a first threshold value. In this way, the merchant-to-mobile distance and a corresponding virtual card may be selected based geographical location criteria. In some examples, the virtual card engine may establish the first threshold value. However in other examples the card service provider may establish the first threshold value. In other embodiments, alternate criteria may be used to determine the selected virtual card. For example, a set of X number of cards having the shortest corresponding merchant-to-mobile distance may be selected. In such an example, steps 902-908 may be repeated multiple times until the card set has been filled with the predetermined number (i.e. X) of cards.

If it is determined that the merchant-to-mobile distance is not less than the first threshold value (NO at 910) the method returns to the start or alternatively in other embodiments ends. However, if the merchant-to-mobile distance is less that the first threshold value (YES at 910) the method may include at 912 presenting the virtual card corresponding to the merchant-to-mobile distance on a display of the mobile computing device. In this way, a virtual card may be quickly and accurately selected just prior to use, decreasing the amount of time a user may spend sorting through virtual cards stored in the virtual card engine.

In some systems, the method may continue at 914. At 914 the method includes accessing the virtual card presented on the display. Steps 916-938 illustrate a specific authentication transaction which uses the geographic identifier, however other methods may be used to authenticate and enable use of the virtual card.

Although shown where the virtual card is presented on a display at 912, it should be appreciated that in some systems, a selective enable request may occur automatically without display or selection by the user. Thus, in some systems, the determination of the merchant-to-mobile distance may be automatically determined and where such distance is below a threshold value, the system may provide automatic selective enablement of a virtual card without user input. In such systems, the user may not need to present and/or access the virtual card on the mobile computing device to enable the authentication of the virtual card.

Continuing with FIG. 3, in some embodiments, the method, at 916, may include sending a selective enablement request to the virtual card manager in response to accessing the virtual card. As discussed above, it should be appreciated that in some embodiments, steps 204-210 may be optional such that a merchant-to-mobile distance is not determined in regards to display of virtual cards. Thus, the method starting at 216 may be a stand-alone method for use to authenticate a virtual card during presentation.

After a selective enablement request is made to the virtual card manager, the method may proceed to 918 where the method includes determining if the merchant-to-mobile distance is less than a second threshold value. However in other embodiments, it may be determined if the merchant-to-mobile distance is within a range of values. Furthermore, it will be appreciated that in some examples the first threshold value may be different from the second threshold value. Additionally, the second threshold value may be established by the card service provider, in some examples. In other examples, the second threshold value may be established by the virtual card engine.

If it is determined that the merchant-to-mobile distance is less than the second threshold value (YES at 918) the method proceeds to 920 where the method includes selectively determining a balance associated with the virtual card. At 921, an offer or promotion relevant to the determined balance may also be determined. Such offer or promotion may be from the merchant with whom the value is issued, or may be from a competing merchant. At step 922, the balance and offer or promotion may be presented to the user.

At 923 enabling a virtual card transaction via the virtual card manager. In some examples, selectively enabling a virtual card transaction may include at 924 permitting authentication of the virtual card.

Next at 925 the method includes sending an authentication request to the virtual card manager from the virtual card engine. At 226 the method includes receiving the authentication request at the virtual card manager. Next at 927 the method includes generating and/or sending an authentication verification to the virtual card engine from the virtual card manager based at least in part on the matched geographic identifier. It will be appreciated that the method may additionally include receiving the authentication verification at the virtual card engine.

Further, in some embodiments, steps 930-938 may be optional such that if the merchant-to-mobile distance is greater than a second threshold value the method ends and there is no enablement or authentication of the virtual card. A dashed line has been added to indicate that steps 930-938 may be optional, alternatives to, or used in combination with, steps 920-938. In other systems, (such as in the illustrated example) the merchant-to-mobile distance may be used to selectively disable a virtual card. For example, if it is determined that the merchant-to-mobile distance is not less than the second threshold value (NO at 918) the method proceeds to 930 where the method includes selectively disabling a virtual card transaction via the virtual card manager. In some examples, selectively disabling a virtual card transaction may include at 932 inhibiting authentication of the virtual card.

As briefly mentioned above, disabling steps 930-938 are provided for exemplary purposes and may be optional or varied depending on the system. In the illustrated example, at 934, the method may include sending an authentication request to the virtual card manager from the virtual card engine and at 936, in some systems, the method may include receiving the authentication request at the virtual card manager. Next, in some systems, at 938 the method may include generating and/or sending an authentication rejection to the virtual card engine from the virtual card manager. It will be appreciated that the method may additionally include receiving the authentication rejection at the virtual card engine.

Thus, the geographical location information may be used with the virtual card manager to ensure that the mobile computing device requesting to use the card is geographically situated at the location that the card holder intends to use the card or is permitted to use the card. The virtual card may be toggled on for use with the card service manager, but also may provide security that the mobile computing device is where it is supposed to be while being used for a select virtual card. In this way, the geographical location of the mobile computing device may be used to increase the security of the virtual card engine, thereby decreasing the likelihood of fraudulent use of a virtual card by a third party. The examples shown in steps 920-938 are provided as illustrative steps and not intended to be limiting.

With reference to FIG. 10, a mobile computing device 1000 which may present various content windows on which one or more virtual cards may be displayed offers or promotions associated with both a proximate merchant and an existing balance of a virtual card, in accordance with some embodiments of the present invention will now be discussed. Mobile computing device 1000 may display an alert 1010 to a user. The alert 1010 may include a notification of the amount of balance 1020 that the user has to spend at a specific merchant 1030, and may also include the distance to the merchant 1040. Moreover, mobile computing device may also present the user with one or more offers or promotions 1050 relevant to the determined value.

For example, the balance associated with the virtual card may be determined to be $3.78. The mobile computing device 1000 may display to the user various offers for the residual balance of $3.78, including for example, a frozen pizza at 1051, a downloadable ringtone at 1052, or three candy bars at 1053. In this manner, the merchant may encourage the user to use the residual value on the virtual card.

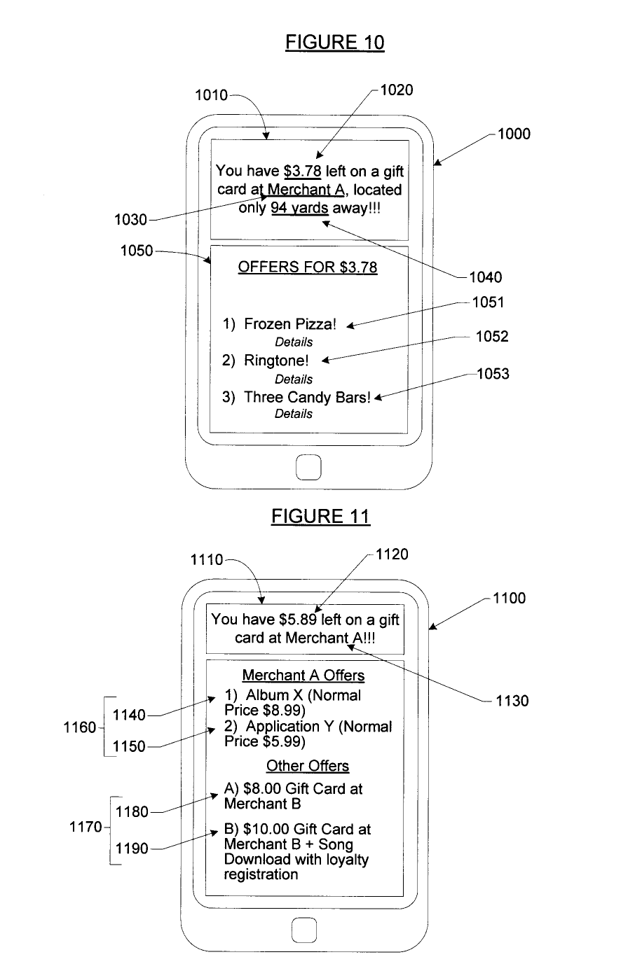

With reference to FIG. 11, offers and promotions may also be presented from competing merchants. With reference to FIG. 11, a mobile computing device 1100 may display an alert 1110 informing a user that he or she has a specific balance ($5.89) 1120 to spend at the specific merchant 1130. As in FIG. 10, the mobile computing device may display one or more offers or promotions from the specific merchant 1160, including, for example, a downloadable album 1140 (which may have a typically higher purchase price, reduced to encourage the user to use the residual value), or an application 1150 for a smart phone.

The mobile computing device may also display offers or promotions from competitor merchants at 1170. Such offers or promotions may be for various items, including but not limited to a purchase of stored value redeemable only at the competing merchant at 1180, or may require additional actions on the part of the user, such as registering for the competing merchant's loyalty program at 1190. In this manner, competing merchant may use residual value on a competitor's virtual card to reduce purchases at the competitor and instead encourage new customers at the competitor.

Note that the goods and/or services depicted in FIGS. 10 and 11 may be physical—such as a material goods or service, or may be virtual products that may be purchased and obtained directly from the mobile computing device.

The systems and methods described above enable a user to quickly access a virtual card which is likely to be used based on a geographical location of a mobile computing device as well as a geographical location of a merchant-outlet. Furthermore, the geographical location of the mobile computing device as well as the merchant-outlet may also be used to provide a heightened level of security during a virtual card transaction.

It is noted that although the above-disclosure is described in regards to virtual cards, it should be appreciated, that in some systems, the geographic identifier and the systems and methods described herein may also be used in connection with event tickets, such as virtual or electronic event tickets. Thus, in such systems, the virtual event ticket may be considered a virtual value card with the access or entrance privileges being considered the stored value. In an example system and method, a geographic identifier may be identified for a mobile computing device. The geographic identifier may be matched with a virtual event ticket. If the geographic identifier matches the geographical location of the virtual event (e.g. the event-to-mobile distance is less than or equal to a threshold value), then access may be provided to the event.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein.

Inventions embodied in various combinations and subcombinations of features, functions, elements, and/or properties may be claimed in a related application. Such claims, whether they are directed to a different invention or directed to the same invention, whether different, broader, narrower or equal in scope to any original claims, are also regarded as included within the subject matter of the inventions of the present disclosure.

What is claimed is:

1. A method for using a virtual gift card having a value associated therewith, the method operable on a mobile computing device having a processor and memory, the mobile computing device operatively linked to a virtual gift card manager, the method comprising:
identifying a geographic identifier for the mobile computing device;
matching the geographic identifier with at least one virtual gift card stored on the mobile computing device;
determining an amount of value associated with the at least one virtual gift card;
identifying any offers or promotions redeemable with the amount of value;
displaying the at least one virtual gift card, the amount of value, and any offers or promotions on the mobile computing device; and
selectively enabling a transaction utilizing the virtual gift card, the transaction based at least in part on the any offers or promotions, the transaction including a manipulation of value associated with the at least one virtual gift card.

2. The method of claim 1, wherein the at least one virtual gift card feature includes a security feature including selectively enabling a virtual gift card transaction based on the at least one virtual gift card with the matched geographic identifier.

3. The method of claim 1, wherein the any offers or promotions are redeemable with a merchant that did not issue the virtual gift card.

4. The method of claim 1, wherein the any offers or promotions comprise offers for the purchase of goods or services for the total amount of value associated with the virtual gift card.

5. The method of claim 1, wherein matching the geographic identifier with at least one virtual gift card executed on the mobile computing device includes determining that the geographic identifier is less than a first threshold value for the at least one virtual gift card.

6. The method of claim 1, wherein matching the geographic identifier with at least one virtual gift card associated executed on the mobile computing device includes comparing geographical location data of a merchant other than the merchant who issued the virtual gift card.

7. A method for management of one or more virtual cards included in a virtual card engine communicatively linked to a virtual card manager, the method comprising:
determining a merchant-to-mobile distance between a mobile computing device location and an at least one merchant-outlet location, wherein the at least one merchant-outlet location is associated with an at least one virtual card stored on the mobile computing device;
determining if the merchant-to-mobile distance is less than a first threshold value;
determining the balance of the at least one virtual card;
determining any promotions or offers redeemable with the balance of the at least one virtual card; and
automatically displaying on the mobile computing device the at least one virtual card, the balance, and any promotions or offers.

8. The method of claim 7, wherein the promotions or offers redeemable with the balance of the at least one virtual card comprise goods or services that are typically sold for a price greater than the balance.

9. The method of claim 7, wherein the virtual card manager determines any promotions or offers based upon accessing a database comprising one or more promotions or offers associated with the merchant-outlet location.

10. The method of claim 7, wherein the virtual card manager determines any promotions or offers based upon communications received from the merchant-outlet location.

11. The method of claim 7, wherein the virtual card manager determines any promotions or offers based upon communications received from an entity associated with the merchant-outlet location.

12. The method of claim 7, wherein automatically displaying on the mobile computing device the at least one virtual card includes presenting a set of virtual cards having a corresponding merchant-to-mobile distance between the mobile computing device and the at least one merchant-outlet, and wherein the balance is an aggregate balance of the set of virtual cards.

13. The method of claim 7, wherein the virtual card engine is executed on the mobile computing device.

14. A method for management of one or more virtual cards included in a virtual card engine communicatively linked to a virtual card manager, the method comprising:
determining a distance between a mobile computing device location of a mobile computing device and at least one merchant-outlet location, the at least one merchant-outlet location linked with a card service provider and at least one virtual card previously stored on the mobile computing device, the card service provider configured to process a virtual card transaction;
determining an amount of value associated with the at least one virtual card;
automatically selectively presenting the at least one virtual card linked with the at least one merchant-outlet location and the amount of value associated with the at least one virtual card on a display of the mobile computing device based on the distance between the mobile computing device location and the at least one merchant-outlet location;
displaying a merchant promotion based on the at least one virtual card and the amount of value; and
selectively enabling a virtual card transaction between at least one virtual card and the card service provider based on the at least one virtual card, the amount of value, and the merchant promotion, the virtual card transaction including a manipulation of value associated with the at least one virtual card.

15. The method of claim 14, wherein selectively presenting at least one virtual card includes presenting a set of virtual cards on the display having a corresponding distance between the mobile computing device and the at least one merchant-outlet location less than a threshold value.

16. The method of claim 14, wherein displaying a merchant promotion based on the at least one virtual card and the amount of value comprises displaying a plurality of merchant promotions that are redeemable with the amount of value.

17. The method of claim 16, wherein the plurality of merchant promotions are redeemable with a one or more merchants, including merchants that did not issue the virtual card.

18. The method of claim 14, wherein the merchant promotion requires additional action on the part of the customer for redemption.

19. The method of claim 18, wherein the additional action comprises the customer registering with the merchant.

20. The method of claim 14, wherein the virtual card is one of a gift card, a membership card, and a rewards card.
